(19) United States
(12) Patent Application Publication
(10) Pub. No.: US 2025/0238972 A1
(43) Pub. Date: Jul. 24, 2025

(54) ATTRIBUTE UPDATE METHOD AND APPARATUS FOR VIRTUAL OBJECT, ELECTRONIC DEVICE, AND COMPUTER-READABLE STORAGE MEDIUM

(71) Applicant: Tencent Technology (Shenzhen) Company Limited, Shenzhen (CN)

(72) Inventors: Jian Xiao, Shenzhen (CN); Chao Tian, Shenzhen (CN); Yao Chen, Shenzhen (CN); Yeqiang Lin, Shenzhen (CN)

(21) Appl. No.: 19/175,520

(22) Filed: Apr. 10, 2025

Related U.S. Application Data
(63) Continuation of application No. PCT/CN2024/078753, filed on Feb. 27, 2024.

(30) Foreign Application Priority Data
Apr. 21, 2023 (CN) 202310461034X

(51) Int. Cl. G06T 11/00

(52) U.S. Cl. CPC G06T 11/00

(57) ABSTRACT

An attribute update method and apparatus for a virtual object, an electronic device, and a computer-readable storage medium are provided. The method includes: obtaining attribute data of attributes of a plurality of virtual objects in a virtual scene; invoking a main thread corresponding to each attribute, splitting the attribute data of each attribute into at least two attribute data fields, creating a data update task of each attribute data field, where each attribute data field corresponds to one splitting dimension, and the data update task indicates to update the attribute data field; for each attribute, invoking a task thread corresponding to each splitting dimension of the attribute, and executing in parallel the data update task of each attribute data field, to obtain a plurality of updated attribute data fields; and updating an attribute of each of the plurality of virtual objects based on the plurality of updated attribute data fields.

### CROSS-REFERENCE TO RELATED APPLICATIONS

This application is a continuation application of PCT Application No. PCT/CN2024/078753, filed on Feb. 27, 2024, which claims priority to Chinese Patent Application No. 202310461034X, filed on Apr. 21, 2023, each entitled “ATTRIBUTE UPDATE METHOD AND APPARATUS FOR VIRTUAL OBJECT, ELECTRONIC DEVICE, COMPUTER-READABLE STORAGE MEDIUM, AND COMPUTER PROGRAM PRODUCT,” and each of which is incorporated herein by reference in its entirety.

### FIELD

The present disclosure relates to the field of computer technologies, and in particular, to an attribute update method and apparatus for a virtual object, an electronic device, a non-transitory computer-readable storage medium, and a computer program product.

### BACKGROUND

With the development of computer technologies, an electronic device can implement a richer and more vivid virtual scene. A virtual scene refers to a digital scene delineated by a computer by using a digital communication technology. A user may obtain a feeling of complete virtualization or a feeling of partial virtualization in aspects such as visual and auditory aspects in the virtual scene, and may control objects in the virtual scene to interact, to obtain a feedback.

For attribute update of a virtual object, attributes of virtual objects are usually updated one by one for the virtual objects in the virtual scene in a serial traversal manner. Consequently, efficiency of updating the attributes of the virtual objects is low.

### SUMMARY

Embodiments of the present disclosure provide an attribute update method and apparatus for a virtual object, an electronic device, a non-transitory computer-readable storage medium, and a computer program product, to effectively improve attribute update efficiency of a virtual object.

The solutions of embodiments of the present disclosure are implemented in this way.

An embodiment of the present disclosure provides an attribute update method for a virtual object, including:
obtaining attribute data of attributes of a plurality of virtual objects in a virtual scene;
invoking a main thread corresponding to each attribute, splitting the attribute data of each attribute into at least two attribute data fields, and creating a data update task of each attribute data field, where
each attribute data field corresponds to one splitting dimension, and the data update task indicates to update the attribute data field;
for each attribute, invoking a task thread corresponding to each splitting dimension of the attribute, and executing in parallel the data update task of each attribute data field, to obtain a plurality of updated attribute data fields; and
updating an attribute of each virtual object based on the plurality of updated attribute data fields.

An embodiment of the present disclosure provides an attribute update apparatus for a virtual object, including:
an obtaining module, configured to obtain attribute data of attributes of a plurality of virtual objects in a virtual scene;
a splitting creation module, configured to: invoke a main thread corresponding to each attribute, split the attribute data of each attribute into at least two attribute data fields, and create a data update task of each attribute data field, where each attribute data field corresponds to one splitting dimension, and the data update task indicates to update the attribute data field;
an execution module, configured to: for each attribute, invoke a task thread corresponding to each splitting dimension of the attribute, and execute in parallel the data update task of each attribute data field, to obtain a plurality of updated attribute data fields; and
an update module, configured to update an attribute of each virtual object based on the plurality of updated attribute data fields.

An embodiment of the present disclosure provides an electronic device, including:
a memory, configured to store computer-executable instructions or a computer program; and
a processor, configured to execute the computer-executable instructions or the computer program stored in the memory, to implement the attribute update method for a virtual object provided in this embodiment of the present disclosure.

An embodiment of the present disclosure provides a non-transitory computer-readable storage medium, storing computer-executable instructions, for causing a processor to execute, and implements the attribute update method for a virtual object provided in this embodiment of the present disclosure.

An embodiment of the present disclosure provides a computer program product. The computer program product includes a computer program or computer-executable instructions, and the computer program or the computer-executable instructions are stored in a non-transitory computer-readable storage medium. A processor of an electronic device reads the computer-executable instructions from the non-transitory computer-readable storage medium, and the processor executes the computer-executable instructions, so that the electronic device performs the attribute update method for a virtual object in this embodiment of the present disclosure.

Embodiments of the present disclosure have the following beneficial effects.

Main threads corresponding to attributes of a plurality of virtual objects in a virtual scene are respectively invoked, attribute data of a corresponding attribute is split into at least two attribute data fields, and a data update task of each attribute data field is created. Then, for each attribute, a task thread corresponding to each splitting dimension of the attribute is invoked, and the data update task of each attribute data field is executed in parallel, to update an attribute of the virtual object based on an obtained plurality of updated attribute data fields. In this way, (1) the attribute data of each attribute is split into attribute data fields by invoking the main threads of the attributes, and an attribute update task of each attribute data field is executed in parallel by using the task thread of each splitting dimension, to update the attribute of the virtual object based on the updated attribute data field. This effectively improves attribute update efficiency of the virtual object. (2) The main thread of each attribute is invoked to split the attribute data of each attribute into at least two attribute data fields, so that when at least two task threads execute data update tasks for a same attribute data field in parallel, a possibility that attribute data fields corresponding to different data update tasks are different greatly increases, occurrence of a read-write conflict caused by updating the same attribute data field by a plurality of parallel data update tasks is reduced, and performance of parallel processing is improved, thereby further improving the attribute update efficiency of the virtual object.

### BRIEF DESCRIPTION OF THE DRAWINGS

FIG. 1 is a diagram of an architecture of an attribute update system for a virtual object according to an embodiment of the present disclosure.

FIG. 2 is a diagram of a structure of an electronic device provided for attribute update of a virtual object according to an embodiment of the present disclosure.

FIG. 3 to FIG. 5 are schematic flowcharts of an attribute update method for a virtual object according to embodiments of the present disclosure.

FIG. 6 is a diagram of an interface of a virtual scene according to an embodiment of the present disclosure.

FIG. 7 to FIG. 9 are principle diagrams of an attribute update method for a virtual object according to embodiments of the present disclosure.

FIG. 10 is a schematic flowchart of an attribute update method for a virtual object according to an embodiment of the present disclosure.

FIG. 11 to FIG. 14 are principle diagrams of an attribute update method for a virtual object according to embodiments of the present disclosure.

### DETAILED DESCRIPTION

The following describes the present disclosure in further detail with reference to the accompanying drawings. The described embodiments are not to be considered as a limitation to the present disclosure. All other embodiments obtained by a person of ordinary skill in the art without creative efforts shall fall within the protection scope of the present disclosure.

In the following description, the term “some embodiments” describes subsets of all possible embodiments, but “some embodiments” may be the same subset or different subsets of all the possible embodiments, and can be combined with each other without conflict.

In the following descriptions, related terms “first\second\third” are merely intended to distinguish between similar objects, and do not indicate a particular order for the objects. “First\second\third” may be interchanged with a particular order or sequence if permitted, so that embodiments of the present disclosure described herein can be implemented in an order other than the order shown or described herein.

Unless otherwise defined, meanings of all terms used in this specification are the same as those usually understood by a person skilled in the art to which the present disclosure belongs. The terms used in the specification are merely intended to describe embodiments of the present disclosure, but are not intended to limit the present disclosure.

Before the embodiments of the present disclosure are further described in detail, a description is made on nouns and terms in the embodiments of the present disclosure, and the nouns and terms in the embodiments of the present disclosure are applicable to the following explanations.

(1) Virtual scene Virtual scene is a virtual scene displayed or provided when an application runs on a terminal. The virtual scene may be a real world simulation environment, a semi-simulation and semi-fiction virtual environment, or a pure-fiction virtual environment. The virtual scene may be any one of a two-dimensional virtual scene, a 2.5-dimensional virtual scene, or a three-dimensional virtual scene. Dimensions of the virtual scene are not limited in embodiments of the present disclosure. For example, the virtual scene may include the sky, the land, the ocean, and the like. The land may include an environment element like a desert or a city, and a user may control a virtual object to move in the virtual scene.

(2) Virtual object Virtual objects are appearances of various persons and objects that can interact with each other in the virtual scene, or movable objects in the virtual scene. The movable object may be a virtual person, a virtual animal, an animation person, or the like. For example, a person, an animal, a plant, an oil barrel, a wall, a stone, or the like displayed in the virtual scene. The virtual object may be a virtual image that is in the virtual scene and that is used to represent a user. The virtual scene may include a plurality of virtual objects, and each virtual object has a shape and a volume in the virtual scene, and occupies some space in the virtual scene. In one embodiment, the virtual object may be a user role controlled by an operation on a client, may be artificial intelligence (AI) set in virtual scene fighting through training, or may be a non-player character (NPC) set in virtual scene interaction. In one embodiment, the virtual object may be a virtual person performing confrontational interaction in a virtual scene. In one embodiment, a quantity of virtual objects participating in interaction in the virtual scene may be preset, or may be dynamically determined based on a quantity of clients participating in the interaction.

3) Virtual object Virtual object is a moving or static object in the virtual scene, and the moving virtual object includes an animal, a vehicle, a person, and the like in the virtual scene. The static virtual object includes a wall, a stone, the ground, and the like in the virtual scene.

4) Virtual engine Virtual engines refer to core components of some editable computer virtual systems or some interactive real-time image applications that have been written. These systems provide various tools required for writing a virtual scene for a designer of the virtual scene, and aim at enabling the designer to easily and quickly write a program. The virtual engines include a rendering engine (the rendering engine includes a two-dimensional rendering engine and a three-dimensional rendering engine), a physical engine, a collision detection engine, a sound effect engine, a script engine, an animation engine, an artificial intelligence engine, a network engine, a scene management engine, and the like.

5) Virtual event Virtual event refers to an event occurs in the virtual scene. For example, a specific virtual object appears at a point A in the virtual scene, two specific virtual objects appear at the point A in the virtual scene, and the two specific virtual objects are in an interactive state. The virtual event includes a plurality of meta events or visualized full-coverage events. A filter condition may be set for each meta event or visualized full-coverage event of the virtual event. Certainly, a virtual event may be formed after a filter condition is set for a single meta event or visualized full-coverage event.

In an implementation of embodiments of the present disclosure, an applicant finds that there are the following problems in the related art.

With the development of game technologies, in scenes such as an open world game, a strategy game (Simulation Game (SLG)), and user interaction space in a virtual reality, a quantity of game players accessing and a quantity of virtual objects controlled by the game players increase exponentially, so that in a same virtual scene, there is more pressure on updating attributes of virtual objects. In a related art, for attribute update of a virtual object, attributes of virtual objects are usually updated one by one for the virtual objects in the virtual scene in a serial traversal manner. Consequently, efficiency of updating the attributes of the virtual objects is low. Due to limitation of hardware performance of a player's terminal, when the efficiency of updating attributes is low, clear frame freezing occurs when high orders of magnitude (thousands or tens of thousands) of players or virtual objects play games in a same virtual scene.

Embodiments of the present disclosure provide an attribute update method and apparatus for a virtual object, an electronic device, a computer-readable storage medium, and a computer program product, to effectively improve attribute update efficiency of a virtual object. Example applications of an attribute update system for a virtual object according to embodiments of the present disclosure are described below.

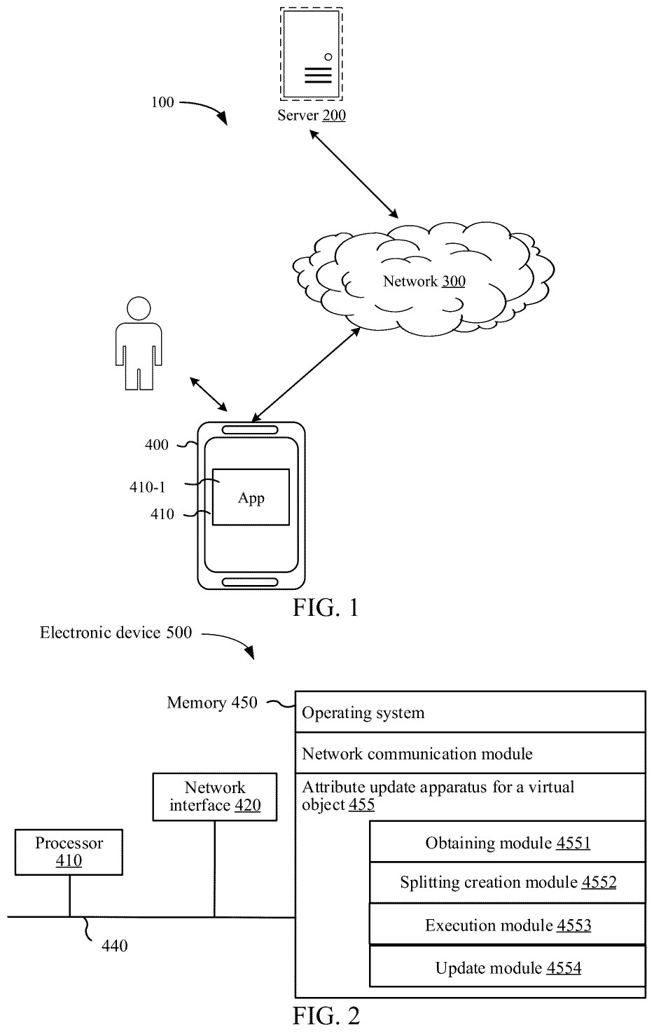

FIG. 1 is a diagram of an architecture of an attribute update system 100 for a virtual object according to an embodiment of the present disclosure. A terminal (for example, a terminal 400) is connected to a server 200 through a network 300. The network 300 may be a wide area network, a local area network, or a combination thereof.

The terminal 400 is configured to display, by a user, a virtual object on a graphical interface 410-1 (the graphical interface 410-1 is shown) through a client 410. The terminal 400 and the server 200 are connected to each other through a wired or wireless network.

In some embodiments, the server 200 may be an independent physical server, or may be a server cluster or a distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The terminal 400 may be a smartphone, a tablet computer, a laptop computer, a desktop computer, a smart speaker, a smart television, a virtual reality device, a smartwatch, a vehicle-mounted terminal, or the like, but is not limited thereto. An electronic device provided in embodiments of the present disclosure may be implemented as a terminal, or may be implemented as a server. The terminal and the server may be directly or indirectly connected in a wired or wireless communication protocol. This is not limited in embodiments of the present disclosure.

In some embodiments, the server 200 sends attribute data of attributes of a plurality of virtual objects in a virtual scene to the terminal 400. The terminal 400 obtains the attribute data of the attributes of the plurality of virtual objects in the virtual scene; invokes a main thread corresponding to each attribute, splits the attribute data of each attribute into at least two attribute data fields, and creates a data update task of each attribute data field; for each attribute, invokes a task thread corresponding to each splitting dimension of the attribute, and executes in parallel the data update task of each attribute data field, to obtain a plurality of updated attribute data fields; and updates an attribute of each virtual object based on the plurality of updated attribute data fields.

In some other embodiments, the terminal 400 sends attribute data of attributes of a plurality of virtual objects in a virtual scene to the server 200. The server 200 obtains the attribute data of the attributes of the plurality of virtual objects in the virtual scene; invokes a main thread corresponding to each attribute, splits the attribute data of each attribute into at least two attribute data fields, and creates a data update task of each attribute data field; for each attribute, invokes a task thread corresponding to each splitting dimension of the attribute, and executes in parallel the data update task of each attribute data field, to obtain a plurality of updated attribute data fields; and updates an attribute of each virtual object based on the plurality of updated attribute data fields.

In some other embodiments, this embodiment of the present disclosure may be implemented by using a cloud technology. The cloud technology refers to a hosting technology that unifies a series of resources such as hardware, software, and a network in a wide area network or a local area network, to implement calculation, storage, processing, and sharing of data. The cloud technology is a collective name of a network technology, an information technology, an integration technology, a management platform technology, an application technology, and the like that are applied based on a cloud computing business mode, and may constitute a resource pool, and is used flexibly and conveniently according to a requirement. A cloud computing technology becomes important support. A background service of a technical network system requires a large quantity of computing and storage resources.

FIG. 2 is a diagram of a structure of an electronic device 500 for updating an attribute of a virtual object according to an embodiment of the present disclosure. The electronic device 500 shown in FIG. 2 may be the server 200 or the terminal 400 in FIG. 1. The electronic device 500 shown in FIG. 2 includes: at least one processor 410, a memory 450, at least one network interface 420. Components in the electronic device 500 are coupled together by using a bus system 440. The bus system 440 is configured to implement connection and communication between these components. In addition to a data bus, the bus system 440 further includes a power bus, a control bus, and a state signal bus. However, for ease of description, all types of buses are marked as the bus system 440 in FIG. 2.

In some embodiments, an attribute update apparatus for a virtual object provided in this embodiment of the present disclosure may be implemented in a software manner. FIG. 2 shows an attribute update apparatus 455 for a virtual object stored in the memory 450. The attribute update apparatus 455 may be software in a form of a program, a plug-in, and the like, and includes the following software modules: an obtaining module 4551, a splitting creation module 4552, an execution module 4553, and an update module 4554. These modules are logical, and therefore may be arbitrarily combined or further split based on an implemented function. Functions of the modules are described below.

In some other embodiments, the attribute update apparatus for a virtual object provided in this embodiment of the present disclosure may be implemented in a hardware manner. For example, the attribute update apparatus for a virtual object provided in this embodiment of the present disclosure may be a processor in a form of a hardware decoding processor, and is programmed to perform the attribute update method for a virtual object provided in this embodiment of the present disclosure. For example, the processor in the form of the hardware decoding processor may use one or more application-specific integrated circuits (ASIC), digital signal processors (DSP), programmable logic devices (PLD), complex programmable logic devices (CPLD), field-programmable gate arrays (FPGA), or other electronic elements.

In some embodiments, a terminal or a server may implement the attribute update method for a virtual object provided in embodiments of the present disclosure by running a computer program or computer-executable instructions. For example, the computer program may be a native program (for example, a dedicated attribute update program of a virtual object) or a software module in an operating system, an attribute update module of a virtual object that may be embedded in any program (for example, an instant messaging client, a photo album program, a digital map client, or a navigation client). For example, the computer program may be a native (native) application, that is, a program that can be run only after being installed in an operating system. In conclusion, the computer program may be an application, a module, or a plug-in in any form.

The attribute update method for a virtual object provided in embodiments of the present disclosure is described with reference to an example application and implementation of a server or a terminal provided in embodiments of the present disclosure.

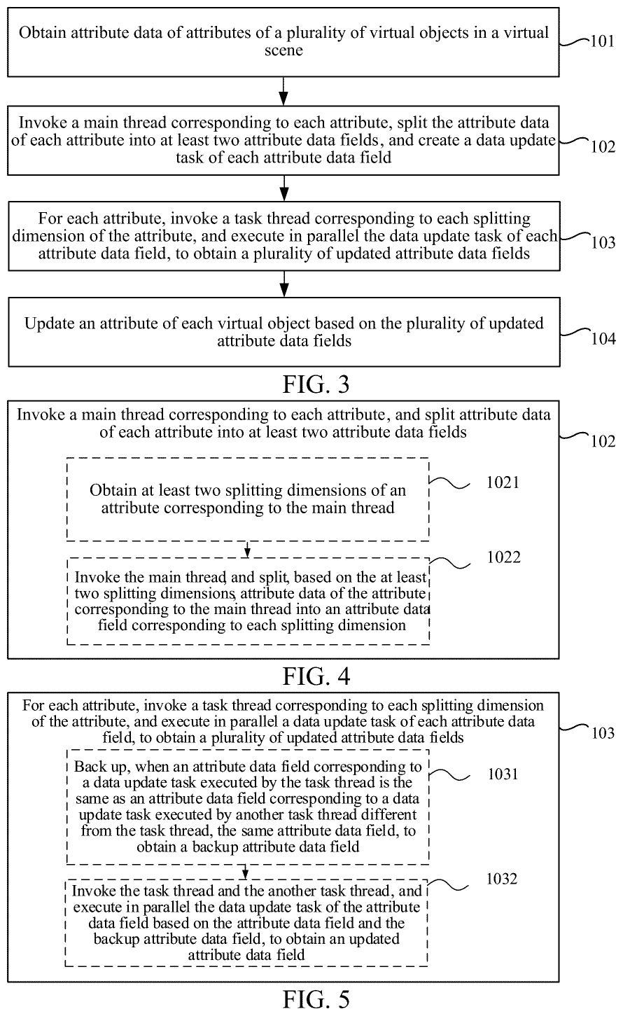

FIG. 3 is a schematic flowchart of an attribute update method for a virtual object according to an embodiment of the present disclosure. Descriptions are provided with reference to operation 101 to operation 104 shown in FIG. 3. The attribute update method for a virtual object provided in this embodiment of the present disclosure may be independently implemented by a server or a terminal, or may be cooperatively implemented by a server and a terminal. The following describes an example in which the terminal independently implements the attribute update method.

Operation 101: Obtain attribute data of attributes of a plurality of virtual objects in a virtual scene.

In some embodiments, operation 101 may be implemented in the following manner: obtaining respective object data of a plurality of virtual objects in the virtual scene and a plurality of attributes of virtual objects; and splitting, for each piece of object data, the object data into attribute data of each attribute.

In some embodiments, each virtual object has object data, different virtual objects have different object data, each virtual object has a plurality of attributes, different virtual objects have a same plurality of attributes, the plurality of attributes of different virtual objects have different attribute data, and one attribute of the virtual object has at least one piece of attribute data.

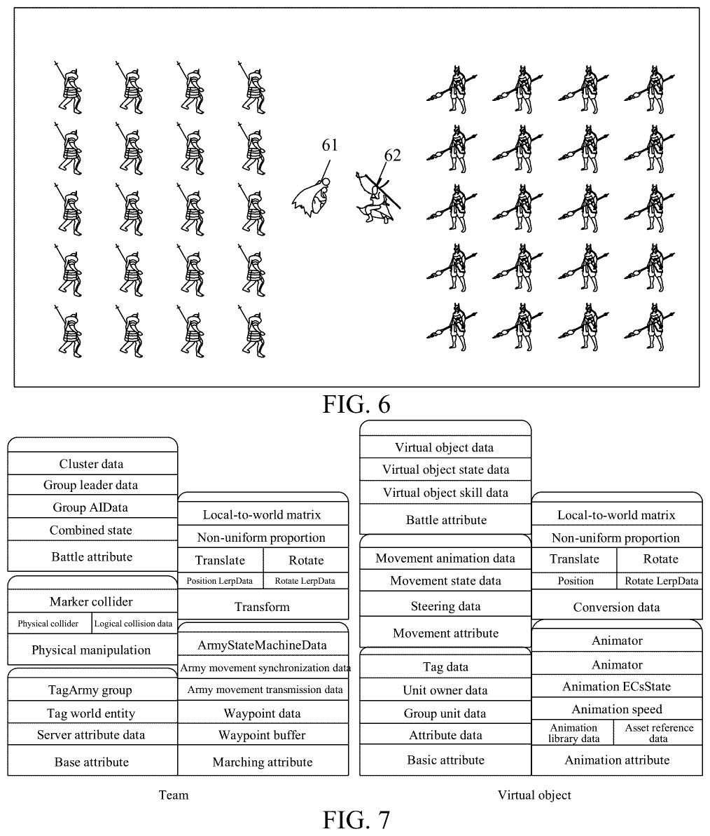

In an example, FIG. 6 is a diagram of an interface of a virtual scene according to an embodiment of the present disclosure. Attribute data of attributes of a plurality of virtual objects (for example, a virtual object 61 and a virtual object 62) in the virtual scene shown in FIG. 6 is obtained. In an example, a plurality of attributes of the virtual object include, but are not limited to, a battle attribute, a movement attribute, a basic attribute, a conversion attribute, and an animation attribute.

In an example, FIG. 7 is a principle diagram of an attribute update method for a virtual object according to an embodiment of the present disclosure. A plurality of attributes of a virtual object include a battle attribute, a movement attribute, a basic attribute, a conversion attribute, and an animation attribute. Attribute data of the battle attribute includes virtual object data, virtual object state data, and virtual object skill data. Attribute data of the movement attribute includes movement animation data, movement state data, and steering data. Attribute data of the basic attribute includes tag data, unit owner data, grouping unit data, and attribute data. Attribute data of the conversion attribute includes a local-to-world matrix, a non-uniform scale, translation, rotation, a position, and the like. Attribute data of the animation attribute includes an animation maker, an animation speed, and the like.

In some other embodiments, operation 101 may be implemented in the following manner: obtaining a plurality of virtual objects in a virtual scene and a plurality of attributes of the virtual objects, and for each virtual object, obtaining attribute data of each attribute of the virtual object.

In this way, the attribute data of the attributes of the plurality of virtual objects in the virtual scene is obtained, so that it is convenient to update the attribute data subsequently, to update the attributes of the virtual objects. The plurality of virtual objects are organized by using the attribute data, and each virtual object does not need to be updated, thereby effectively improving attribute update efficiency of the virtual object.

Operation 102: Invoke a main thread corresponding to each attribute, split the attribute data of each attribute into at least two attribute data fields, and create a data update task of each attribute data field.

Each attribute data field corresponds to one splitting dimension, and the data update task of the attribute data field indicates to update the attribute data field.

In some embodiments, before operation 102 is performed, a state of the main thread may further be set to an initialization state in the following manner: obtaining a plurality of main threads sorted in priority order, one main thread corresponding to one attribute, and one attribute corresponding to at least one main thread; and sequentially setting a state of each main thread to the initialization state based on the priority order.

Each main thread has a corresponding priority, and the priority of the main thread indicates a priority of performing task processing by the main thread and performing processing on the main thread. One main thread corresponds to one attribute, but one attribute may correspond to at least one main thread. Therefore, states of main threads may be sequentially set to the initialization state based on the sequence indicated by the priority order.

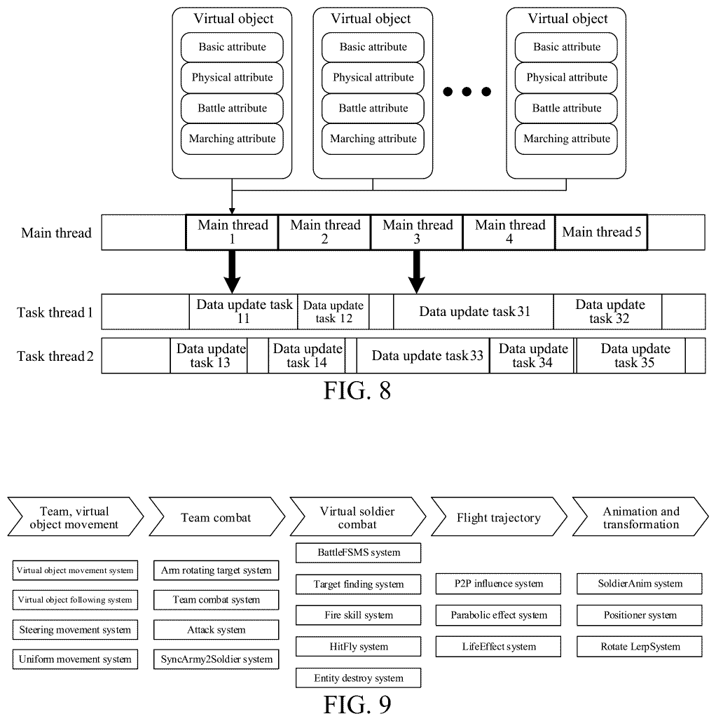

In an example, FIG. 8 is a principle diagram of an attribute update method for a virtual object according to an embodiment of the present disclosure. A plurality of main threads (for example, a main thread 1, a main thread 2, a main thread 3, a main thread 4, and a main thread 5 that are shown in FIG. 8, where a priority of the main thread 1 is the highest, and a priority of the main thread 5 is the lowest) that are sorted based on priorities are obtained. The main thread 1 corresponds to a basic attribute of the virtual object. The main thread 2 corresponds to a marching attribute of the virtual object. The main thread 3 corresponds to a battle attribute of the virtual object. The main thread 4 corresponds to a physical attribute of the virtual object. The main thread 5 corresponds to a battle attribute of the virtual object. One main thread corresponds to one attribute. The basic attribute of the virtual object corresponds to the main thread 1, the battle attribute of the virtual object corresponds to the main thread 3 and the main thread 5, and one attribute corresponds to at least one (one or more) main thread. States of the main thread 1, the main thread 2, the main thread 3, the main thread 4, and the main thread 5 are sequentially set to the initialization state based on the priority order.

In some embodiments, operation 102 may be implemented in the following manner: when the state of the main thread is set to the initialization state, determining a target attribute corresponding to the main thread in attributes of the plurality of virtual objects; and invoking the main thread, and split attribute data of the target attribute into at least two attribute data fields. When the state of the main thread is set to the initialization state, the attribute data may be split. In some examples, in a process of sequentially setting the states of the main threads, a main thread whose state is set to the initialization state may split attribute data. In this way, efficiency of splitting attribute data by the main thread can be improved, thereby improving attribute update efficiency of the virtual object.

In an example, referring to FIG. 8, in a process of sequentially setting the states of the main thread 1, the main thread 2, the main thread 3, the main thread 4, and the main thread 5, when the state of the main thread 1 is set to the initialization state, a target attribute (a basic attribute) corresponding to the main thread 1 is determined from the attributes (the basic attribute, the physical attribute, the battle attribute, and the marching attribute) of the plurality of virtual objects, and the main thread 1 is invoked, to split attribute data of the basic attribute into at least two attribute data fields. When the state of the main thread 2 is set to the initialization state, a target attribute (a marching attribute) corresponding to the main thread 2 is determined from the attributes (the basic attribute, the physical attribute, the battle attribute, and the marching attribute) of the plurality of virtual objects, and the main thread 2 is invoked to split attribute data of the marching attribute into at least two attribute data fields.

In an example, the attribute data of the basic attribute may be “dxwedwef”, and the main thread 2 is invoked to split the attribute data “dxwedwef” of the basic attribute into an attribute data field “dxw” and an attribute data field “edwef”.

In some embodiments, the obtaining a plurality of main threads sorted based on a priority order may be implemented in the following manner: obtaining an attribute priority of each attribute; creating, for each attribute, at least one main thread corresponding to the attribute, and determining the attribute priority of the attribute as a priority of each main thread corresponding to the attribute; and sorting the main threads based on the priority order of the main threads, to obtain the plurality of main threads sorted based on the priority order.

One main thread corresponds to one attribute, and one attribute corresponds to at least one main thread. At least one main thread corresponding to each attribute may be created, attribute priorities of the attributes are determined as priorities of the main threads corresponding to the attributes, and the main threads are sorted based on the priorities of the main threads, to obtain the plurality of main threads sorted based on the priority order. Herein, the priority of the main thread is actually the attribute priority of the attribute corresponding to the main thread. In this way, when the main thread of each attribute is invoked based on the priority for processing, processing may be performed based on the attribute priority of the attribute.

In some embodiments, the attribute priority is in positive correlation with a degree of impact of attribute data of a corresponding attribute on the virtual object. A larger degree of impact of the attribute data of the attribute on the virtual object indicates a higher attribute priority of the attribute. A smaller degree of impact of the attribute data of the attribute on the virtual object indicates a smaller attribute priority of the attribute. In this way, attribute data of an attribute having a higher impact degree can be preferentially processed, thereby improving timeliness of updating the attribute of the virtual object.

In an example, referring to FIG. 8, the attribute priority of the attribute is obtained. For example, an attribute priority of the basic attribute is the highest, an attribute priority of the physical attribute is the second highest, an attribute priority of the battle attribute is the second lowest, and an attribute priority of the marching attribute is the lowest. A main thread 1 corresponding to the basic attribute is created, a main thread 2 corresponding to the physical attribute is created, a main thread 3 and a main thread 4 corresponding to the battle attribute are created, and a main thread 5 corresponding to the marching attribute is created. The attribute priority corresponding to the attribute is determined as the priority of each main thread corresponding to the attribute. For example, the attribute priority of the basic attribute: the highest level determined as a priority of the main thread 1 corresponding to the basic attribute. The attribute priority of the physical attribute: the second highest priority determined as a priority of the main thread 2 corresponding to the physical attribute. The attribute priority of the battle attribute: the second lowest level determined as priorities of the main thread 3 and the main thread 4 corresponding to the battle attribute. The main threads are sorted based on the priority order of the main threads, to obtain a plurality of main threads (the main thread 1, the main thread 2, the main thread 3, and the main thread 4) sorted based on the priority order.

In some embodiments, the sequentially setting a state of each main thread to an initialization state based on the priority order may be implemented in the following manner: setting a state of a first main thread in the plurality of main threads to the initialization state, and the first main thread being a main thread with a highest priority in the plurality of main threads; and traversing i to perform the following processing: setting, when an i^{th} main thread of the plurality of main threads completes splitting the attribute data field of the attribute, a state of an (i+1)^{th} main thread to the initialization state.

In some embodiments, a priority of the ith main thread is greater than or equal to a priority of the (i+1)^{th} main thread, i is a positive integer not less than 1, i is less than or equal to N−1, and Nis a total quantity of the main threads.

In an example, the state of the first main thread is set to the initialization state, and the first main thread is a main thread with a highest priority. When the first main thread completes splitting an attribute data field of a corresponding attribute, a state of a second main thread is set to the initialization state. When the second main thread completes splitting an attribute data field of a corresponding attribute, a state of a third main thread is set to the initialization state. When the third main thread completes splitting an attribute data field of a corresponding attribute, a state of a fourth main thread is set to the initialization state.

In an example, referring to FIG. 8, when the main thread 1 completes splitting the attribute data field of the corresponding attribute, the state of the main thread 2 is set to the initialization state. When the state of the main thread 2 is set to the initialization state, a target attribute corresponding to the main thread 2 is determined from attributes (the basic attribute, the physical attribute, the battle attribute, and the marching attribute) of a plurality of virtual objects, and the main thread 2 is invoked to split attribute data of the basic attribute into at least two attribute data fields. When the main thread 2 completes splitting the attribute data field of the corresponding attribute, the state of the main thread 3 is set to the initialization state.

In this way, splitting of attribute data fields and creation of a data update task are completed by serially executing each main thread based on the priority. Because the priority is determined based on the attribute priority of each attribute and the attribute priority is positively correlated to a degree of impact of attribute data corresponding to a corresponding attribute on the virtual object, attribute data having a larger impact degree indicates higher priority of performing, by the corresponding main thread, the splitting of the attribute data fields and the creation of the data update task. Based on an execution sequence of the main threads determined according to the impact degree, attribute data corresponding to an attribute having a larger impact degree can be preferentially processed, thereby effectively improving timeliness of updating an attribute of the virtual object.

In some embodiments, FIG. 4 is a schematic flowchart of a virtual event generation method according to an embodiment of the present disclosure. In operation 102 shown in FIG. 3, the “invoking a main thread corresponding to each attribute, and splitting attribute data of each attribute into at least two attribute data fields” may be implemented by separately performing operation 1021 and operation 1022 shown in FIG. 4 for each main thread.

Operation 1021: Obtain at least two splitting dimensions of an attribute corresponding to the main thread.

In some embodiments, the splitting dimensions include different splitting dimensions such as a data type dimension and a data function dimension. A specific type of the splitting dimension and a quantity of the splitting dimensions do not constitute a limitation to this embodiment of the present disclosure.

Operation 1022: Invoke the main thread, and split, based on the at least two splitting dimensions, attribute data of the attribute corresponding to the main thread into an attribute data field corresponding to each splitting dimension.

In some embodiments, each piece of data in the attribute data field belongs to a same splitting dimension, and attribute data fields corresponding to different splitting dimensions are different. Each attribute has at least two corresponding splitting dimensions.

In an example, referring to FIG. 8, the main thread 1 is invoked, and attribute data of a basic attribute corresponding to the main thread 1 is separately split, based on at least two splitting dimensions, into attribute data fields respectively corresponding to the splitting dimensions. In an example, referring to FIG. 8, the main thread 2 is invoked, and attribute data of a basic attribute corresponding to the main thread 2 is split, based on at least two splitting dimensions, into attribute data fields corresponding to the splitting dimensions.

After the attribute data of each attribute is split into at least two attribute data fields, a data update task of each attribute data field is further created. In some embodiments, each attribute data field corresponds to one splitting dimension, and the data update task indicates to update a corresponding attribute data field.

In an example, referring to FIG. 8, each piece of attribute data of the basic attribute corresponding to the main thread 1 is split, based on a splitting dimension A, a splitting dimension B, a splitting dimension C, and a splitting dimension D, into attribute data fields respectively corresponding to the splitting dimension A, the splitting dimension B, the splitting dimension C, and the splitting dimension D. A data update task 11 of an attribute data field corresponding to the splitting dimension A is created, a data update task 12 of an attribute data field corresponding to the splitting dimension B is created, a data update task 13 of an attribute data field corresponding to the splitting dimension C is created, and a data update task 14 of an attribute data field corresponding to the splitting dimension D is created.

In an example, referring to FIG. 8, each piece of attribute data of the basic attribute corresponding to the main thread 3 is split, based on a splitting dimension A, a splitting dimension B, a splitting dimension C, a splitting dimension D, and a splitting dimension E, into attribute data fields respectively corresponding to the splitting dimension A, the splitting dimension B, the splitting dimension C, the splitting dimension D, and the splitting dimension E. A data update task 31 of an attribute data field corresponding to the splitting dimension A is created, a data update task 32 of an attribute data field corresponding to the splitting dimension B is created, a data update task 33 of an attribute data field corresponding to the splitting dimension C is created, and a data update task 34 of an attribute data field corresponding to the splitting dimension D is created.

In this way, by invoking the main thread, each piece of attribute data of an attribute corresponding to the main thread is split, based on at least two splitting dimensions, into attribute data fields respectively corresponding to the splitting dimensions, to subsequently create, for each attribute data field, a data update task corresponding to each attribute data field. Because the attribute data field is a subset of the attribute data, the attribute data is split, not only a data update amount of data update tasks is effectively reduced and execution efficiency of the data update tasks is improved, but also different data update tasks update same attribute data, different attribute data fields of same attribute data may be respectively updated, thereby effectively avoiding a possibility that an update conflict occurs when the same attribute data is updated.

Operation 103: For each attribute, invoke a task thread corresponding to each splitting dimension of the attribute, and execute in parallel the data update task of each attribute data field, to obtain a plurality of updated attribute data fields.

One splitting dimension corresponds to one task thread, and one task thread corresponds to at least one splitting dimension. The task threads are executed in parallel.

In an example, referring to FIG. 8, for the basic attribute, task threads 1 corresponding to the splitting dimension A and the splitting dimension B are invoked, and task threads 2 corresponding to the splitting dimension C and the splitting dimension D are invoked. The task thread 1 and the task thread 2 are executed in parallel. When the task thread 1 executes the data update task 11, the task thread 2 executes the data update task 13 and the data update task 14. When the task thread 2 executes the data update task 14, the task thread 1 executes the data update task 11 and the data update task 12. When the task thread 1 executes the data update task 12, the task thread 2 executes the data update task 14.

In some embodiments, before operation 103 is performed, a target task thread may further be determined in the following manner: creating a target quantity of task threads; and performing the following processing on each attribute: obtaining a dimension quantity of splitting dimension of the attribute; dividing the dimension quantity by the target quantity, to obtain a division result; and determining, based on the division result, a target task thread corresponding to each splitting dimension of the attribute in the target quantity of task threads.

In some embodiments, the target quantity of the task threads is less than a maximum quantity of concurrent threads that can be carried by a hardware device. Specific setting of the target quantity does not constitute a limitation to this embodiment of the present disclosure. In this way, an effect of concurrent execution of the task threads can be ensured, and resource utilization of the hardware device can be improved.

In an example, referring to FIG. 8, two task threads (the task thread 1 and the task thread 2 shown in FIG. 8) are created to perform the following processing on the basic attribute. A dimension quantity (4) of splitting dimensions corresponding to the basic attribute is obtained, and the dimension quantity (4) is divided by a target quantity (2), to obtain a division result (2). A target task thread corresponding to each splitting dimension of the basic attribute is determined from the task thread 1 and the task thread 2 based on the division result (target task threads corresponding to the data update task 11 and the data update task 12 are the task thread 1, and target task threads corresponding to the data update task 13 and the data update task 14 are the task thread 2).

In some embodiments, operation 103 may be further implemented in the following manner: for each attribute, invoking a target task thread corresponding to each splitting dimension of the attribute, and executing in parallel the data update task of each attribute data field, to obtain a plurality of updated attribute data fields.

In an example, referring to FIG. 8, for the basic attribute, the task thread 1 and the task thread 2 corresponding to each splitting dimension of the basic attribute are invoked, and data update tasks of attribute data fields are executed in parallel (the task thread 1 executes the data update task 11 and the data update task 12, and the task thread 2 executes the data update task 13 and the data update task 14).

In some embodiments, the determining, in a plurality of task threads based on the division result, a target task thread corresponding to each splitting dimension of the attribute may be implemented in the following manner: when a value of the division result is less than 1, allocating one task thread to each splitting dimension, and task threads allocated to different splitting dimensions are different; and when the value of the division result is greater than or equal to 1, allocating one task thread to each splitting dimension, and a difference between a quantity of splitting dimensions allocated to one task thread and the division result is less than a difference threshold; and determining a task thread allocated to each splitting dimension as the target task thread corresponding to each splitting dimension. In this way, task threads can be properly allocated, so that execution efficiency of a data update task is higher.

In an example, referring to FIG. 8, the following processing is performed on the basic attribute. A dimension quantity (4) of splitting dimensions corresponding to the basic attribute is obtained; and the dimension quantity (4) is divided by a target quantity (2), to obtain a division result (2). When a value of the division result is greater than 1, one task thread is allocated to each splitting dimension, and a difference between a quantity of splitting dimensions allocated to one task thread and the division result is less than a difference threshold. A quantity of splitting dimensions allocated to the task thread 1 is 2; a quantity of splitting dimensions allocated to the task thread 2 is 2; target task threads corresponding to the data update task 11 and the data update task 12 are the task thread 1; and target task threads corresponding to the data update task 13 and the data update task 14 are the task thread 2.

In this way, the target task thread corresponding to each splitting dimension of the attribute is determined in the plurality of task threads, so that data update tasks are evenly distributed to different task threads, and efficiency of executing in parallel the data update tasks by different target task threads is more efficient. This effectively improves concurrent execution efficiency of the task threads.

In some embodiments, FIG. 5 is a schematic flowchart of a virtual event generation method according to an embodiment of the present disclosure. Operation 103 shown in FIG. 3 may be implemented by separately performing operation 1031 and operation 1032 shown in FIG. 5 for each task thread.

Operation 1031: Back up, when the attribute data field corresponding to the data update task executed by the task thread is the same as an attribute data field corresponding to a data update task executed by another task thread different from the task thread, the same attribute data field, to obtain a backup attribute data field.

In some embodiments, when the attribute data field corresponding to the data update task currently executed by the task thread is different from an attribute data field corresponding to a data update task currently executed by another task thread, the task thread and the another task thread continue to concurrently execute a corresponding data update task.

In some embodiments, when an attribute data field corresponding to a data update task currently executed by a task thread is the same as an attribute data field corresponding to a data update task currently executed by another task thread, that is, two different task threads still conflict, the same attribute data field is backed up, to obtain a backup attribute data field. Through the backup attribute data field and the attribute data field, data update tasks respectively corresponding to the task thread and the another task thread are supported, thereby effectively avoiding a read-write conflict caused when the task thread and the another task thread respectively execute different data update tasks on a same attribute data field.

Operation 1032: Invoke the task thread and the another task thread, and execute in parallel a data update task of the attribute data field based on the attribute data field and the backup attribute data field, to obtain an updated attribute data field.

In some embodiments, the data update task includes at least one of a read task used for reading the attribute data field and a write task used for writing the attribute data field.

In some embodiments, operation 1032 may be implemented in the following manner: invoking the another task thread to execute a read task corresponding to the backup attribute data field when there is a read task for the attribute data field in a process in which the task thread executes the write task for the attribute data field; and invoking, in a process in which the task thread executes the read task for the attribute data field and when there is a write task for the attribute data field, the another task thread to execute a corresponding write task for the backup attribute data field.

In an example, referring to FIG. 8, the task thread 2 is invoked to execute a read task corresponding to the backup attribute data field when there is a read task for the attribute data field in a process in which the task thread 1 executes the write task for the attribute data field. In a process in which the task thread 1 executes the read task for the attribute data field and when there is a write task for the attribute data field, the task thread 2 is invoked to execute a corresponding write task for the backup attribute data field.

In this way, in a process in which the task thread executes the write task or the read task for the attribute data field, when the read task or the write task for the attribute data field exists, another task thread is invoked, to execute a read task or a write task corresponding to the backup attribute data field, to back up the same attribute data field, to obtain the backup attribute data field. Through the backup attribute data field and the attribute data field, data update tasks respectively corresponding to the task thread and the another task thread are supported, thereby effectively avoiding a read-write conflict caused when the task thread and the another task thread respectively execute different data update tasks on a same attribute data field.

In some embodiments, in a process of updating the attribute of each virtual object, a main thread corresponding to each attribute is invoked to create respective re-update tasks of a plurality of updated attribute data fields. For each attribute, a task thread corresponding to each splitting dimension of the attribute is invoked, and respective re-update tasks of a plurality of updated attribute data fields are executed in parallel, to obtain a plurality of re-updated attribute data fields. The attribute of each virtual object is re-updated based on the plurality of re-updated attribute data fields.

In some embodiments, in a process of updating an attribute of each virtual object, main threads corresponding to the attribute may be separately invoked, and a re-update task of the attribute data field is created and executed without waiting for the completion of updating the attribute of the virtual object, to obtain a plurality of re-updated attribute data fields. After updating of the attribute of each virtual object is completed, the attribute of each virtual object continues to be re-updated based on the plurality of re-updated attribute data fields.

In this way, in the process of updating the attribute of each virtual object, the main threads corresponding to the attribute may be separately invoked, and the re-update task of the attribute data field is created and executed without waiting for the completion of updating the attribute of the virtual object, thereby effectively improving efficiency of iteratively updating the attribute of the virtual object.

Operation 104: Update an attribute of each virtual object based on the plurality of updated attribute data fields.

In some embodiments, operation 104 may be implemented in the following manner: performing updating and rendering on an attribute of each virtual object based on the plurality of updated attribute data fields, to obtain a virtual object with an updated attribute.

In some embodiments, in the process of executing in parallel the data update task of each attribute data field by invoking the task thread corresponding to each splitting dimension, the scene element in the virtual scene other than the virtual object may be updated in the following manner: obtaining scene element data of the scene element in the virtual scene other than the virtual object; invoking a main thread corresponding to the scene element, and updating the scene element data, to obtain updated scene element data; and updating the scene element based on the updated scene element data.

In this way, in the process of executing in parallel the data update task of each attribute data field by invoking the task thread corresponding to each splitting dimension, the scene elements other than the virtual object in the virtual scene are updated in parallel, so that all virtual elements in the virtual scene are updated in parallel with full coverage, to effectively improve update efficiency of the virtual scene.

By applying the foregoing embodiment, main threads corresponding to attributes of a plurality of virtual objects in a virtual scene are respectively invoked, attribute data of a corresponding attribute is split into at least two attribute data fields, and a data update task of each attribute data field is created. For each attribute, a task thread corresponding to each splitting dimension of the attribute is invoked, and the data update task of each attribute data field is executed in parallel, to update the attribute of the virtual object based on an obtained plurality of updated attribute data fields. In this way, (1) the attribute data of each attribute is split into attribute data fields by invoking the main threads of the attributes, and an attribute update task of each attribute data field is executed in parallel by using the task thread of each splitting dimension, to update the attribute of the virtual object based on the updated attribute data field. This effectively improves attribute update efficiency of the virtual object. (2) The main thread of each attribute is invoked to split the attribute data of each attribute into at least two attribute data fields, so that when at least two task threads execute data update tasks for a same attribute data field in parallel, a possibility that attribute data fields corresponding to different data update tasks are different greatly increases, occurrence of a read-write conflict caused by updating the same attribute data field by a plurality of parallel data update tasks is reduced, and performance of parallel processing is improved, thereby further improving the attribute update efficiency of the virtual object.

The following describes an example application of this embodiment of the present disclosure to an actual application scene of updating an attribute of a virtual object. According to this embodiment of the present disclosure, an order of magnitude (thousands or tens of thousands) of players or virtual objects may smoothly play game in a same virtual scene on a mobile terminal. On a mobile device, due to limitation of hardware performance, a developer needs to pay more attention to application performance, to avoid occupying excessive power and CPU resources. Therefore, how to achieve a combat effect of an order of magnitude of virtual objects on a mobile terminal with limited performance, so that each virtual object can smoothly present an animation and trigger skill logic, ensure image smoothness without frame freezing, and reduce power consumption becomes a research topic. Refer to FIG. 6. Through this embodiment of the present disclosure, an effect that a high order of magnitude of virtual objects fight can be achieved, and a multi-kernel feature of a mobile phone can be fully used to improve multi-linear parallel efficiency and a frame rate, and reduce power consumption.

In this embodiment of the present disclosure, by using a UnityDOTS-based framework and a comprehensive set of solutions, a mobile device can support interaction in a one-screen thousand-person 3D virtual scene, achieving a good representation effect and high operating efficiency. Details are described below.

In some embodiments, referring to FIG. 7, data of an implementation team and a virtual object includes attribute data used in all battles, for example, virtual object data, virtual object state data, virtual object skill data, movement animation data, and movement state data.

In some embodiments, referring to FIG. 8, a procedure of logic update of a virtual object in a single system includes filtering virtual object attributes, collecting virtual object units, creating a task for logic update, and scheduling a task to be executed in another thread. Because there are a plurality of logical systems during interaction in a virtual scene, there are a plurality of tasks for reading and writing attributes of a same virtual object, and the tasks are scheduled in different systems, and there is a competitive read-write conflict in sequence.

In some embodiments, FIG. 9 is a principle diagram of an attribute update method for a virtual object according to an embodiment of the present disclosure. The system shown in FIG. 8 may be used to process logic update in interaction in a virtual scene, implementing multi-thread concurrent logic in the interaction. Filtering is performed in different systems based on attributes of virtual objects, and logic of a corresponding system is updated for a virtual object that satisfies a filter condition. In this system, virtual objects are grouped by blocks, and all virtual objects in a single block are distributed to other threads by using tasks for execution, implementing multi-thread running of interaction logic.

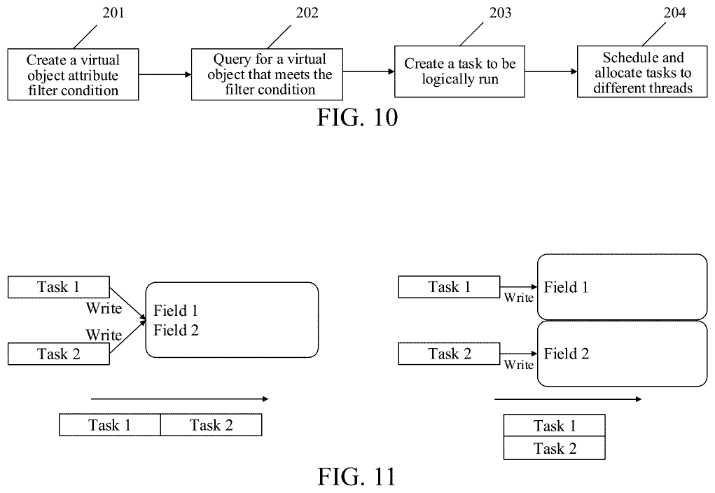

In some embodiments, FIG. 10 is a schematic flowchart of an attribute update method for a virtual object according to an embodiment of the present disclosure. Execution logic of a single system may be implemented by using operation 201 to operation 204 shown in FIG. 10.

Operation 201: Create a virtual object attribute filter condition.

Operation 202: Query for a virtual object that meets the filter condition.

Operation 203: Create a task to be logically run.

Operation 204: Schedule and allocate tasks to different threads.

In some embodiments, FIG. 11 is a principle diagram of an attribute update method for a virtual object according to an embodiment of the present disclosure. To improve concurrency efficiency of multi-thread in an architecture of E (a game object Entity) C (Component) S (System), thread concurrency logic needs to be well designed, to prevent threads from competing and waiting when a plurality of threads write into a same memory data block (attribute data) at the same time. In embodiments of the present disclosure, logical splitting of a finer granularity is used, and a single concurrent task processes only a single logical data field, so that data in a same structural body is split into two structural bodies, which may be provided for two different systems to concurrently read and write, thereby improving concurrent efficiency. There is a write logic for a same attribute in different tasks. In this way, a write conflict occurs at a same moment, so that the two tasks cannot be executed in parallel. When the two tasks write different fields of the same attribute, the two fields may be divided into two sub-attributes, so that different tasks write different sub-attributes, to avoid multi-thread contention of the write conflict, and divide a data field to improve concurrent performance. FIG. 11 shows an implementation principle. A write conflict occurs when “a field 1 and a field 2” are written into both of the task 1 and the task 2. Therefore, the “the field 1 and the field 2” are split into two different data blocks. The task 1 may be specific to the field 1, and the task 2 may be specific to the field 2, to independently and parallelly write data.

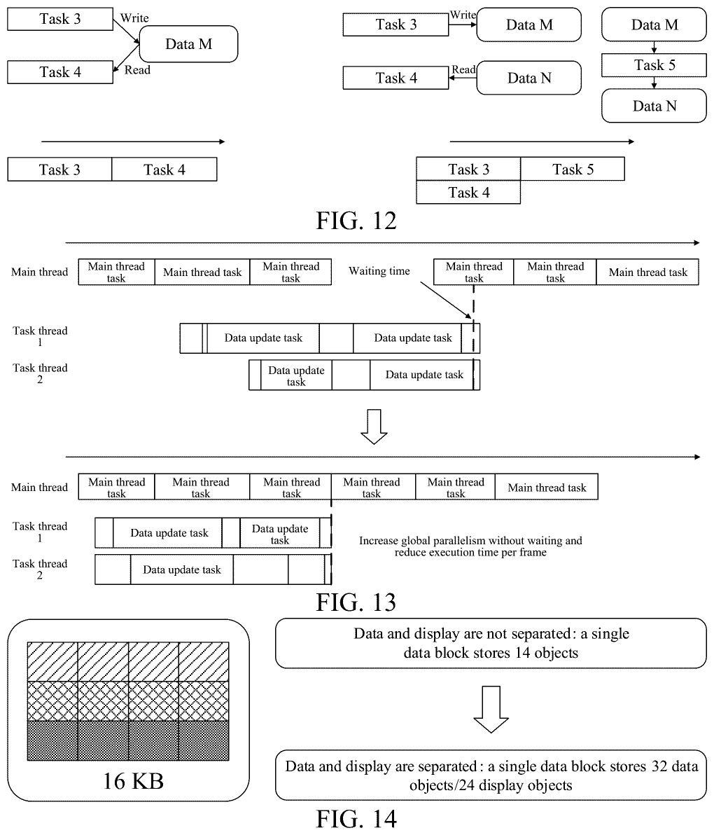

In some embodiments, FIG. 12 is a principle diagram of an attribute update method for a virtual object according to an embodiment of the present disclosure. Referring to FIG. 12, in multi-thread development, one thread (a task 3) writes a data block (referring to data M in FIG. 12) at the same time, and another thread (a task 4) reads a same data block after the previous thread (the task 3) is written completely. This may cause logical serial blocking. At a same moment, there is a case in which an attribute is filtered out by tasks in two systems. In this case, writing by one task and reading by one task cause a read-write conflict. Therefore, the attribute is copied by one piece of temporary data, so that reading and writing may be separated. Two corresponding tasks may alternatively be executed in parallel, and synchronization only needs to be performed once at the tail of a frame. In this embodiment of the present disclosure, a written data block (the data M) is copied by one temporary data block (the data M and a data N), and an original data block is synchronized to a copied data block at the tail of each frame, so that a write thread and a read thread can be completely separated without a read-write dependency, to improve multi-thread concurrency. As shown in FIG. 12, for threads (the task 3 and the task 4) that write and read a same data block, a complete copy of the data block is performed, and data synchronization is performed at the tail of the frame, to avoid thread waiting caused by a read and write conflict (after the data M is replicated to obtain the data M and the data N, the task 3 and the task 4 may be run in parallel without a conflict). After a task 5 runs in parallel with the task 3 and the task 4, the task 5 reads the data M, and writes the data M into the data N.

In some embodiments, FIG. 13 is a principle diagram of an attribute update method for a virtual object according to an embodiment of the present disclosure. When execution time is long, subsequent logical execution may be delayed, but a space area exists previously. Only a main thread is executing at this stage. Consequently, utilization of a central processor is wasted. In this embodiment of the present disclosure, innovatively, a high-time ECS execution logic and a non-ECS execution logic are parallelized, to improve global parallelism, reduce overall execution time, and improve a picture frame rate. As shown in FIG. 13, when a main thread task and a data update task of a task thread cannot run in parallel, the main thread task can continue to run only after waiting for corresponding waiting time. Global parallelism optimization is performed on the main thread task and the data update task, so that the main thread task of the main thread does not wait any more. This improves utilization of a central processing unit, reduces single-frame execution time, increases global parallelism without waiting, and reduces execution time per frame.

In some embodiments, FIG. 14 is a principle diagram of an attribute update method for a virtual object according to an embodiment of the present disclosure. Some overheads of fighting of a high order of magnitude of virtual objects come from resource loading consumption of the virtual objects. When data and display are not separated, logic operation needs to wait for display resources to be updated after being loaded. This means that when 1000 virtual objects on a same screen are loaded simultaneously, logic waiting time is greatly increased, and frame freezing is caused. Therefore, data and display need to be separated, so that a logical update part of the data does not depend on execution after all resources are loaded, but may be independently updated, and a logical part and a display part are mapped and associated with each other until resources are loaded. In this way, picture fluency can be improved. As shown in the following figure, data and display separation increases a quantity of objects in a single data block. A virtual object includes two phases from logic update to animation display. The logic update phase processes a behavior of the virtual object, including movement, rotation, attribute change, and the like. An animation update part processes only animation display of the virtual object. Even if there is no animation display, logic of the virtual object can still perform normal update operations. This part is synchronous with an attribute of the virtual object on a server. The virtual object display part is only work performed by a client to present an image to a player, and includes animation triggering of the virtual object, character model display, and the like. For a data block having a storage space of 16 KB, when data and display are not separated, 14 objects are stored in a single data block. When data and display are separated, a single data block stores 32 data objects/24 display objects.

In some embodiments, a calculation amount of fighting by a virtual object of an order of magnitude at a mobile terminal is large, but the mobile terminal has a feature of small electricity and passive heat removal. Therefore, it is necessary to reduce power consumption of an application. After logical separation of data and display is performed, a logical operation may be controlled to be 12 frames per second. In this way, an overall logical operation amount is reduced during a long-time combat, to reduce power consumption.

In embodiments of the present disclosure, related data such as attribute data is involved. When embodiments of the present disclosure are applied to a specific product or technology, user permission or consent needs to be obtained, and the related data needs to be collected, used, and processed by complying with related laws and regulations and standards of a related country and region.

The following continues to describe an example structure in which an attribute update apparatus 455 for a virtual object provided in this embodiment of the present disclosure is implemented as a software module. In some embodiments, as shown in FIG. 2, the software module in the attribute update apparatus 455 for a virtual object stored in the memory 450 may include: an obtaining module 4551, configured to obtain attribute data of attributes of a plurality of virtual objects in a virtual scene; a splitting creation module 4552, configured to: invoke a main thread corresponding to each attribute, split the attribute data of each attribute into at least two attribute data fields, and create a data update task of each attribute data field, where each attribute data field corresponds to one splitting dimension, and the data update task indicates to update the attribute data field; an execution module 4553, configured to: for each attribute, invoke a task thread corresponding to each splitting dimension of the attribute, and execute in parallel the data update task of each attribute data field, to obtain a plurality of updated attribute data fields; and an update module 4554, configured to update an attribute of each virtual object based on the plurality of updated attribute data fields.

In some embodiments, the attribute update apparatus 455 of the virtual object further includes: an initialization module, configured to obtain a plurality of main threads sorted in priority order, one main thread corresponding to one attribute, and one attribute corresponding to at least one main thread; and sequentially set a state of each main thread to an initialization state based on the priority order. The splitting creation module is further configured to: separately perform the following processing for each main thread: when the state of the main thread is set to the initialization state, determine a target attribute corresponding to the main thread in the attributes of the plurality of virtual objects; and invoke the main thread, and split attribute data of the target attribute into at least two attribute data fields.

In some embodiments, the initialization module is further configured to: obtain an attribute priority of each attribute; and create, for each attribute, at least one main thread corresponding to the attribute, and determine the attribute priority of the attribute as a priority of each main thread corresponding to the attribute; and sorting the main threads based on the priority order of the main threads, to obtain the plurality of main threads sorted based on the priority order.

In some embodiments, the initialization module is further configured to: set a state of a first main thread in the plurality of main threads to the initialization state, and the first main thread is a main thread with a highest priority in the plurality of main threads; and traverse i to perform the following processing: setting, when an i^{th} main thread of the plurality of main threads completes splitting the attribute data field of the attribute, a state of an (i+1)^{th} main thread to the initialization state. A priority of the i^{th} main thread is greater than or equal to a priority of the (i+1)^{th} main thread, i is a positive integer not less than 1, i is less than or equal to N−1, and N is a total quantity of the main threads.

In some embodiments, the splitting creation module 4552 is further configured to: separately perform the following processing for each main thread: obtain at least two splitting dimensions of an attribute corresponding to the main thread; and invoke the main thread, and split, based on the at least two splitting dimensions, the attribute data of the attribute corresponding to the main thread into an attribute data field corresponding to each splitting dimension.

In some embodiments, the attribute update apparatus 455 of the virtual object further includes: a target task thread module, configured to create a target quantity of task threads; and perform the following processing on each attribute: obtaining a dimension quantity of splitting dimension of the attribute; dividing the dimension quantity by the target quantity, to obtain a division result; and determining, based on the division result, a target task thread corresponding to each splitting dimension of the attribute in the target quantity of task threads. The execution module is further configured to: for each attribute, invoke a target task thread corresponding to each splitting dimension of the attribute, and execute in parallel the data update task of each attribute data field, to obtain a plurality of updated attribute data fields.

In some embodiments, the execution module 4553 is further configured to: when a value of the division result is less than 1, allocate one task thread to each splitting dimension, and task threads allocated to different splitting dimensions are different; and when the value of the division result is greater than or equal to 1, allocate one task thread to each splitting dimension, and a difference between a quantity of splitting dimensions allocated to one task thread and the division result is less than a difference threshold; and determine a task thread allocated to each splitting dimension as the target task thread corresponding to each splitting dimension.

In some embodiments, the execution module 4553 is further configured to perform the following processing on each task thread: backing up, when the attribute data field corresponding to the data update task executed by the task thread is the same as an attribute data field corresponding to a data update task executed by another task thread different from the task thread, the same attribute data field, to obtain a backup attribute data field; and invoking the task thread and the another task thread, and executing in parallel a data update task of the attribute data field based on the attribute data field and the backup attribute data field, to obtain an updated attribute data field.

In some embodiments, the data update task includes at least one of a read task used for reading the attribute data field and a write task used for writing the attribute data field. The execution module 4553 is further configured to: invoke the another task thread to execute a read task corresponding to the backup attribute data field when there is a read task for the attribute data field in a process in which the task thread executes the write task for the attribute data field; and invoke, in a process in which the task thread executes the read task for the attribute data field and when there is the write task for the attribute data field, the another task thread to execute a corresponding write task for the backup attribute data field.

In some embodiments, the attribute update apparatus 455 of the virtual object further includes: a re-update module, configured to: invoke, in a process of updating the attribute of each virtual object, a main thread corresponding to each attribute, to create a re-update task of a plurality of updated attribute data fields; For each attribute, a task thread corresponding to each splitting dimension of the attribute is invoked, and respective re-update tasks of a plurality of updated attribute data fields are executed in parallel, to obtain a plurality of re-updated attribute data fields. The attribute of each virtual object is re-updated based on the plurality of re-updated attribute data fields.

In some embodiments, the attribute update apparatus 455 of the virtual object further includes: a scene element update module, configured to: obtain scene element data of a scene element in the virtual scenes other than the virtual object; invoke a main thread corresponding to the scene element, and updating the scene element data, to obtain updated scene element data; and update the scene element based on the updated scene element data.

An embodiment of the present disclosure provides a computer program product. The computer program product includes a computer program or computer-executable instructions, and the computer program or the computer-executable instructions are stored in a computer-readable storage medium. A processor of an electronic device reads the computer-executable instructions from the computer-readable storage medium, and the processor executes the computer-executable instructions, so that the electronic device performs the attribute update method for a virtual object in this embodiment of the present disclosure.

An embodiment of the present disclosure provides a computer-readable storage medium storing computer-executable instructions. The computer-executable instructions are stored in the computer-readable storage medium. When the computer-executable instructions are executed by a processor, the processor is enabled to perform the attribute update method for a virtual object provided in embodiments of the present disclosure, for example, the attribute update method for a virtual object shown in FIG. 3.

In some embodiments, the computer-readable storage medium may be a memory like an FRAM, a ROM, a PROM, an EPROM, an EEPROM, a flash memory, a magnetic surface memory, an optical disc, or a CD-ROM, or may be various electronic devices including one or any combination of the memories.

In some embodiments, the computer-executable instructions may be in a form of a program, software, a software module, a script, or code, written in any form of programming language (including compiled or interpreted languages, or declarative or procedural languages), and may be deployed in any form, including being deployed as an independent program or being deployed as a module, a component, a subroutine, or another unit suitable for being used in a computing environment.

In an example, the computer-executable instructions may but not necessarily correspond to a file in a file system, and may be stored in a part of a file that stores other programs or data, for example, stored in one or more scripts in a hypertext markup language (Hyper Text Markup Language (HYML)) document, stored in a single file dedicated to a program in question, or stored in a plurality of cooperative files (for example, files that store one or more modules, subprograms, or code parts).

In an example, the computer-executable instructions may be deployed to be executed on one electronic device, or to be executed on a plurality of electronic devices located at one site, or to be executed on a plurality of electronic devices distributed at a plurality of sites and interconnected through a communication network.

In conclusion, embodiments of the present disclosure have the following beneficial effects.

(1) Main threads corresponding to attributes of a plurality of virtual objects in a virtual scene are respectively invoked, attribute data of a corresponding attribute is split into at least two attribute data fields, and a data update task of each attribute data field is created. For each attribute, a task thread corresponding to each splitting dimension of the attribute is invoked, and the data update task of each attribute data field is executed in parallel, to update the attribute of the virtual object based on an obtained plurality of updated attribute data fields. In this way, (1.1) the attribute data of each attribute is split into attribute data fields by invoking a main thread of each attribute, and an attribute update task of each attribute data field is executed in parallel by using task threads of splitting dimensions, to update an attribute of a virtual object based on an updated attribute data field. This effectively improves attribute update efficiency of the virtual object. (1.2) The main thread of each attribute is invoked to split the attribute data of each attribute into at least two attribute data fields, so that when at least two task threads execute data update tasks for a same attribute data field in parallel, a possibility that attribute data fields corresponding to different data update tasks are different greatly increases, occurrence of a read-write conflict caused by updating the same attribute data field by a plurality of parallel data update tasks is reduced, and performance of parallel processing is improved, thereby further improving the attribute update efficiency of the virtual object.

(2) In this way, the attribute data corresponding to each attribute of the plurality of virtual objects in the virtual scene is obtained, so that it is convenient to update the attribute data subsequently, to update the attributes of the virtual objects. The plurality of virtual objects are organized by using the attribute data, and each virtual object does not need to be updated independently, thereby effectively improving the attribute update efficiency of the virtual object.

(3) Splitting of attribute data fields and creation of a data update task are completed by serially executing each main thread based on the priority. Because the priority is determined based on the attribute priority of each attribute and the attribute priority is positively correlated to a degree of impact of attribute data corresponding to a corresponding attribute on the virtual object, attribute data having a larger impact degree indicates higher priority of performing, by the corresponding main thread, the splitting of the attribute data fields and the creation of the data update task. Based on an execution sequence of the main threads determined according to the impact degree, attribute data corresponding to an attribute having a larger impact degree can be preferentially processed, thereby effectively improving timeliness of updating an attribute of the virtual object.

(4) By invoking the main thread, each piece of attribute data of an attribute corresponding to the main thread is split, based on at least two splitting dimensions, into attribute data fields corresponding to the splitting dimensions, to subsequently create, for each attribute data field, a data update task corresponding to each attribute data field. Because the attribute data field is a subset of the attribute data, the attribute data is split, a data update amount of data update tasks is effectively reduced, different data update tasks update same attribute data, different attribute data fields of the same attribute data may be respectively updated, thereby effectively avoiding a possibility that an update conflict occurs when the same attribute data is updated.

(5) The target task thread corresponding to each splitting dimension of the attribute is determined in the plurality of task threads, so that data update tasks are evenly distributed to different task threads, and efficiency of executing in parallel the data update tasks by different target task threads is more efficient, to effectively improve concurrent execution efficiency of the task threads.

(6) In a process in which the task thread executes the write task or the read task for the attribute data field, when there is a read task or a write task for the attribute data field, another task thread is invoked, to execute a read task or a write task corresponding to a backup attribute data field, to back up the same attribute data field, to obtain the backup attribute data field. Through the backup attribute data field and the attribute data field, data update tasks respectively corresponding to the task thread and the another task thread are supported. This effectively avoids a read-write conflict caused when the task thread and the another task thread respectively execute different data update tasks on a same attribute data field.

(7) In the process of updating the attribute of each virtual object, the main threads corresponding to the attribute may be separately invoked, and a re-update task of the attribute data field is created and executed without waiting for the completion of updating the attribute of the virtual object, thereby effectively improving efficiency of iteratively updating the attribute of the virtual object.

(8) In the process of executing in parallel the data update task corresponding to each attribute data field by invoking the task thread corresponding to each splitting dimension, scene elements other than the virtual object in the virtual scene are updated in parallel, so that all virtual elements in the virtual scene are updated in parallel with full coverage, to effectively improve update efficiency of the virtual scene.

The foregoing descriptions are merely examples of the present disclosure and are not intended to limit the protection scope of the present disclosure. Any modification, equivalent replacement, or improvement made without departing from the spirit and scope of the present disclosure shall fall within the protection scope of the present disclosure.

What is claimed is:

1. An attribute update method for a virtual object, applied to an electronic device, comprising:
obtaining attribute data of attributes of a plurality of virtual objects in a virtual scene;
invoking a main thread corresponding to each attribute, splitting the attribute data of each attribute into at least two attribute data fields, and creating a data update task of each attribute data field, wherein each attribute data field corresponds to one splitting dimension, and the data update task indicates to update the attribute data field;
for each attribute, invoking a task thread corresponding to each splitting dimension of the attribute, and executing in parallel the data update task of each attribute data field, to obtain a plurality of updated attribute data fields; and
updating an attribute of each of the plurality of virtual objects based on the plurality of updated attribute data fields.

2. The method according to claim 1, wherein before the invoking the main thread corresponding to each attribute, and the splitting the attribute data of each attribute into the at least two attribute data fields, the method further comprises:
obtaining a plurality of main threads sorted in priority order, one main thread corresponding to one attribute, and one attribute corresponding to at least one main thread; and
sequentially setting a state of each main thread to an initialization state based on the priority order; and
wherein the invoking the main thread corresponding to each attribute, and the splitting the attribute data of each attribute into the at least two attribute data fields comprises:
performing the following processing for each main thread:
based on the state of the main thread being set to the initialization state, determining a target attribute corresponding to the main thread in the attributes of the plurality of virtual objects; and
invoking the main thread, and splitting attribute data of the target attribute into the at least two attribute data fields.

3. The method according to claim 2, wherein the obtaining the plurality of main threads sorted in priority order comprises:
obtaining an attribute priority of each attribute;
creating, for each attribute, at least one main thread corresponding to the attribute, and determining the attribute priority of the attribute as a priority of each main thread corresponding to the attribute; and
sorting the main threads based on a priority order of the main threads, to obtain the plurality of main threads sorted in priority order.

4. The method according to claim 2, wherein the sequentially setting the state of each main thread to the initialization state based on the priority order comprises:
setting a state of a first main thread in the plurality of main threads to the initialization state, and the first main thread is a main thread with a highest priority in the plurality of main threads; and
traversing i to perform the following processing: setting, based on an i^{th} main thread in the plurality of main threads completing splitting the attribute data field of the attribute, a state of an (i+1)^{th} main thread to the initialization state, wherein
a priority of the i^{th} main thread is greater than or equal to a priority of the (i+1)^{th} main thread, i is a positive integer not less than 1, i is less than or equal to N−1, and N is a total quantity of the plurality of main threads.

5. The method according to claim 1, wherein the invoking the main thread corresponding to each attribute, and the splitting the attribute data of each attribute into the at least two attribute data fields comprises:
performing the following processing for each main thread:
obtaining at least two splitting dimensions of an attribute corresponding to the main thread; and
invoking the main thread, and splitting, based on the at least two splitting dimensions, attribute data of the attribute corresponding to the main thread into an attribute data field corresponding to each splitting dimension.

6. The method according to claim 1, wherein for each attribute, before the invoking the task thread corresponding to each splitting dimension of the attribute, and the executing in parallel the data update task of each attribute data field, to obtain the plurality of updated attribute data fields, the method further comprises:
creating a target quantity of task threads; and
performing the following processing for each attribute:
obtaining a dimension quantity of splitting dimensions of the attribute;
dividing the dimension quantity by the target quantity, to obtain a division result; and
determining, based on the division result, a target task thread corresponding to each splitting dimension of the attribute in the target quantity of task threads; and
wherein for each attribute, the invoking the task thread corresponding to each splitting dimension of the attribute, and the executing in parallel the data update task of each attribute data field, to obtain the plurality of updated attribute data fields comprises:
for each attribute, invoking the target task thread corresponding to each splitting dimension of the attribute, and executing in parallel the data update task of each attribute data field, to obtain the plurality of updated attribute data fields.

7. The method according to claim 6, wherein the determining, based on the division result, the target task thread corresponding to each splitting dimension of the attribute in the target quantity of task threads comprises:
based on a value of the division result being less than 1, allocating one task thread to each splitting dimension, and wherein task threads allocated to different splitting dimensions are different;
based on the value of the division result being greater than or equal to 1, allocating one task thread to each splitting dimension, and wherein a difference between a quantity of splitting dimensions allocated to one task thread and the division result is less than a difference threshold; and
determining the task thread allocated to each splitting dimension as the target task thread corresponding to each splitting dimension.

8. The method according to claim 1, wherein for each attribute, the invoking the task thread corresponding to each splitting dimension of the attribute, and the executing in parallel the data update task of each attribute data field, to obtain the plurality of updated attribute data fields comprises:
performing the following processing for each task thread:
backing up, based on an attribute data field corresponding to a data update task executed by the task thread being the same as an attribute data field corresponding to a data update task executed by another task thread different from the task thread, the same attribute data field, to obtain a backup attribute data field; and
invoking the task thread and the other task thread, and executing in parallel the data update task of the attribute data field based on the attribute data field and the backup attribute data field, to obtain an updated attribute data field.

9. The method according to claim 8, wherein the data update task comprises at least one of a read task used for reading the attribute data field and a write task used for writing the attribute data field; and
the invoking the task thread and the other task thread, and the executing in parallel the data update task of the attribute data field based on the attribute data field and the backup attribute data field, to obtain the updated attribute data field comprises:
invoking the other task thread to execute a read task corresponding to the backup attribute data field based on there being a read task for the attribute data field in a process in which the task thread executes the write task for the attribute data field; and
invoking the other task thread to execute a write task corresponding to the backup attribute data field based on there being a write task for the attribute data field in a process in which the task thread executes the read task for the attribute data field.

10. The method according to claim 1, further comprising:
invoking, in a process of updating the attribute of each of the plurality of virtual objects, the main thread corresponding to each attribute, to create respective re-update tasks of the plurality of updated attribute data fields;
for each attribute, invoking the task thread corresponding to each splitting dimension of the attribute, and executing in parallel the respective re-update tasks of the plurality of updated attribute data fields, to obtain a plurality of re-updated attribute data fields; and
re-updating the attribute of each of the plurality of virtual objects based on the plurality of re-updated attribute data fields.

11. The method according to claim 1, wherein in a process of invoking the task thread corresponding to each splitting dimension, and executing in parallel the data update task of each attribute data field, the method further comprises:
obtaining scene element data of a scene element in the virtual scene other than the virtual object;
invoking a main thread corresponding to the scene element, and updating the scene element data, to obtain updated scene element data; and
updating the scene element based on the updated scene element data.

12. An electronic device, wherein the electronic device comprises:
one or more processors; and
memory storing instructions that, when executed by the one or more processors, cause the electronic device to perform:
obtaining attribute data of attributes of a plurality of virtual objects in a virtual scene;
invoking a main thread corresponding to each attribute, splitting the attribute data of each attribute into at least two attribute data fields, and creating a data update task of each attribute data field, wherein each attribute data field corresponds to one splitting dimension, and the data update task indicates to update the attribute data field;
for each attribute, invoking a task thread corresponding to each splitting dimension of the attribute, and executing in parallel the data update task of each attribute data field, to obtain a plurality of updated attribute data fields; and
updating an attribute of each of the plurality of virtual objects based on the plurality of updated attribute data fields.

13. The electronic device according to claim 12, wherein before the invoking the main thread corresponding to each attribute, and the splitting the attribute data of each attribute into the at least two attribute data fields, the instructions, when executed by the one or more processors, cause the electronic device to perform:
obtaining a plurality of main threads sorted in priority order, one main thread corresponding to one attribute, and one attribute corresponding to at least one main thread; and
sequentially setting a state of each main thread to an initialization state based on the priority order; and
wherein the invoking the main thread corresponding to each attribute, and the splitting the attribute data of each attribute into the at least two attribute data fields comprises:
performing the following processing for each main thread:
based on the state of the main thread being set to the initialization state, determining a target attribute corresponding to the main thread in the attributes of the plurality of virtual objects; and
invoking the main thread, and splitting attribute data of the target attribute into the at least two attribute data fields.

14. The electronic device according to claim 13, wherein the instructions, when executed by the one or more processors, cause the electronic device to perform:
obtaining an attribute priority of each attribute;
creating, for each attribute, at least one main thread corresponding to the attribute, and determining the attribute priority of the attribute as a priority of each main thread corresponding to the attribute; and
sorting the main threads based on a priority order of the main threads, to obtain the plurality of main threads sorted in priority order.

15. The electronic device according to claim 13, wherein the instructions, when executed by the one or more processors, cause the electronic device to perform:
setting a state of a first main thread in the plurality of main threads to the initialization state, and the first main thread is a main thread with a highest priority in the plurality of main threads; and
traversing i to perform the following processing: setting, based on an i^{th} main thread in the plurality of main threads completing splitting the attribute data field of the attribute, a state of an (i+1)^{th} main thread to the initialization state, wherein
a priority of the i^{th} main thread is greater than or equal to a priority of the (i+1)^{th} main thread, i is a positive integer not less than 1, i is less than or equal to N−1, and N is a total quantity of the plurality of main threads.

16. The electronic device according to claim 12, wherein the instructions, when executed by the one or more processors, cause the electronic device to perform:
performing the following processing for each main thread:
obtaining at least two splitting dimensions of an attribute corresponding to the main thread; and
invoking the main thread, and splitting, based on the at least two splitting dimensions, attribute data of the attribute corresponding to the main thread into an attribute data field corresponding to each splitting dimension.

17. The electronic device according to claim 12, wherein for each attribute, before the invoking the task thread corresponding to each splitting dimension of the attribute, and the executing in parallel the data update task of each attribute data field, to obtain the plurality of updated attribute data fields, the instructions, when executed by the one or more processors, cause the electronic device to perform:
creating a target quantity of task threads; and
performing the following processing for each attribute:
obtaining a dimension quantity of splitting dimensions of the attribute;
dividing the dimension quantity by the target quantity, to obtain a division result; and
determining, based on the division result, a target task thread corresponding to each splitting dimension of the attribute in the target quantity of task threads; and
wherein for each attribute, the invoking the task thread corresponding to each splitting dimension of the attribute, and the executing in parallel the data update task of each attribute data field, to obtain the plurality of updated attribute data fields comprises:
for each attribute, invoking the target task thread corresponding to each splitting dimension of the attribute, and executing in parallel the data update task of each attribute data field, to obtain the plurality of updated attribute data fields.

18. The electronic device according to claim 17, wherein the instructions, when executed by the one or more processors, cause the electronic device to perform:
based on a value of the division result being less than 1, allocating one task thread to each splitting dimension, and wherein task threads allocated to different splitting dimensions are different;
based on the value of the division result being greater than or equal to 1, allocating one task thread to each splitting dimension, and wherein a difference between a quantity of splitting dimensions allocated to one task thread and the division result is less than a difference threshold; and
determining the task thread allocated to each splitting dimension as the target task thread corresponding to each splitting dimension.

19. The electronic device according to claim 12, wherein the instructions, when executed by the one or more processors, cause the electronic device to perform:
performing the following processing for each task thread:
backing up, based on an attribute data field corresponding to a data update task executed by the task thread being the same as an attribute data field corresponding to a data update task executed by another task thread different from the task thread, the same attribute data field, to obtain a backup attribute data field; and
invoking the task thread and the other task thread, and executing in parallel the data update task of the attribute data field based on the attribute data field and the backup attribute data field, to obtain an updated attribute data field.

20. A non-transitory computer-readable storage medium, having computer-executable instructions stored thereon, the computer-executable instructions, when executed by one or more processors of an electronic device, cause the electronic device to perform:
obtaining attribute data of attributes of a plurality of virtual objects in a virtual scene;
invoking a main thread corresponding to each attribute, splitting the attribute data of each attribute into at least two attribute data fields, and creating a data update task of each attribute data field, wherein each attribute data field corresponds to one splitting dimension, and the data update task indicates to update the attribute data field;
for each attribute, invoking a task thread corresponding to each splitting dimension of the attribute, and executing in parallel the data update task of each attribute data field, to obtain a plurality of updated attribute data fields; and
updating an attribute of each of the plurality of virtual objects based on the plurality of updated attribute data fields.
